(19) United States
(12) Patent Application Publication
(10) Pub. No.: US 2015/0241249 A1
(43) Pub. Date: Aug. 27, 2015

(54) SENSOR SYSTEM FOR DETECTING POSITION OF TARGET MEMBER

(71) Applicant: Caterpillar Inc., Peoria, IL (US)

(72) Inventors: Joshua A. Mason, Washington, IL (US); Sang J. Kim, Evanston, IL (US); Joseph A. Gillispie, Chicago, IL (US); Michael H. Memmel, Bolingbrook, IL (US); John P. Toyne, Washington, IL (US)

(73) Assignee: Caterpillar Inc., Peoria, IL (US)

(21) Appl. No.: 14/709,499

(22) Filed: May 12, 2015

(51) Int. Cl. G01D 5/22; H01F 27/28; H01F 27/40

(52) U.S. Cl. CPC G01D 5/22; H01F 27/402; H01F 27/28

(57) ABSTRACT

A sensor system for detecting position of a target member relative to a receiving member is disclosed. The sensor system includes a circuit board. The circuit board includes a first and second inductive coils configured to generate first and a second inductive signals, respectively, in response to a movement between the target member relative to the receiving member. The circuit board includes an inductive sensing unit configured to generate first and digital signals based on the first and second inductive signals, respectively. The circuit board includes a processing unit configured to generate an output indicative of the movement between the target member and the receiving member based on a ratio or difference between the first and second digital signals. The sensor system further includes a housing assembly structured and arranged to encase the circuit board. The housing assembly is coupled to one of the target member and the receiving member.

### TECHNICAL FIELD

The present disclosure relates to a sensor system for detecting position of a target member relative to a receiving member.

### BACKGROUND

Electrical sensors include contacts, such as brushes, slip rings, wire conductors, or the like, to indicate a position of a movable member. As sliding electric contact may cause noise and vibrations due to relative movement, these electrical measuring sensors may not be desirable for detecting the position of certain targets, such as a transmission synchronizing ring, a cylinder piston, a throttle valve, or the like. Moreover, accuracy of the readings of such sensors may be reduced due to the vibrations.

For reference, U.S. Pat. No. 4,638,250 (the '250 patent) discloses a position sensor device which inductively measures the change in position of a shorted conductive loop coil that is oriented to move in conjunction with the machine part to be measured relative to a stationary assembly. The stationary assembly is made up of a magnetic field generator and a sensor, which are oriented to respectively create and receive the magnetic field which is coupled to the loop. As a result, displacement of the coupling coil varies the degree of coupling between the generator and sensor such that the magnitude of the induced electrical current is representative of the location of the loop relative to the stationary assembly. The device can be used for measuring angular rotation, linear position and the angle of rotation, and linear movement with respect to displacement from a predetermined null position. However, the loop coil of the '250 patent is disposed directly on a surface of the machine part. Hence, the coil may be susceptible to damage during movement of the machine part. Further, the position sensor of the '250 patent includes a separate magnetic field generator and a sensor in addition to the loop coil. This may increase cost and complexity of the position sensor disclosed by the '250 patent.

### SUMMARY OF THE DISCLOSURE

In an aspect of the present disclosure, a sensor system for detecting a position of a target member relative to a receiving member is disclosed. The sensor system includes a circuit board. The circuit board includes a first inductive coil configured to generate a first inductive signal in response to a movement between the target member relative to the receiving member. The circuit board further includes a second inductive coil being positioned adjacent to the first inductive coil. The second inductive coil is configured to generate a second inductive signal in response to movement between the target member relative to the receiving member. The circuit board further includes an inductive sensing unit disposed in communication with the first inductive coil and the second inductive coil. The inductive sensing unit is configured to generate a first digital signal and a second digital signal based on the first inductive signal and the second inductive signal, respectively. The circuit board further includes a processing unit disposed in communication with the inductive sensing unit. The processing unit is configured to generate an output indicative of the movement between the target member and the receiving member based on at least one of ratio and difference between the first digital signal and the second digital signal. The sensor system also includes a housing assembly structured and arranged to encase the circuit board. Further, the circuit board is disposed in the housing assembly. The housing assembly is coupled to one of the target member and the receiving member. The target member is placed in proximity to the receiving member and a range of movement is defined by the distance the target member travels relative to the receiving member. Further, the circuit board is configured to sense a position of the target member relative to the receiving member within the range of movement between the target member and the receiving member.

Other features and aspects of this disclosure will be apparent from the following description and the accompanying drawings.

### BRIEF DESCRIPTION OF THE DRAWINGS

FIG. 1 is a perspective view of a sensor system, according to an embodiment of the present disclosure;

FIG. 2 is a sectional view of the sensor system along a line A-A′ in FIG. 1, according to an embodiment of the present invention;

FIG. 3 is a block diagram illustrating the sensor system, according to an embodiment of the present disclosure;

FIG. 4 is an exemplary output of the sensor system;

FIG. 5 is a front view of the sensor system, according to another embodiment of the present disclosure; and

FIG. 6 is a sectional view of the sensor system along a line B-B′ in FIG. 5, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

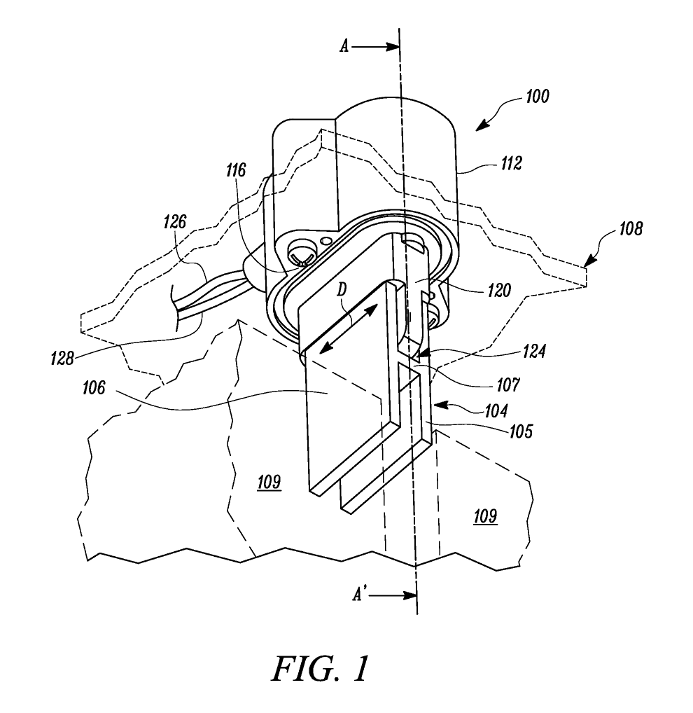

FIG. 1 shows a perspective view of a sensor system 100, according to an embodiment of the present disclosure. The sensor system 100 may be used to detect a position of a target member 104 relative to a receiving member 108. The target member 104 is placed in proximity to the receiving member 108. In the illustrated embodiment, the target member 104 includes a first portion 105, a second portion 106 disposed adjacent to the first portion 105, and an intermediate portion 107 disposed between the first portion 105 and the second portion 106. The first portion 105, the second portion 106 and the intermediate portion 107 may be structured and arranged to define a recessed portion 124. In the illustrated embodiment, the target member 104 is coupled to a first component 109 (shown by dashed lines). The target member 104 may be coupled to the first component 109 via various methods, for example, welding, mechanical fasteners, adhesives, and the like. The first component 109 may be movable, for example, a synchro-ring of a transmission unit of a machine. Further, the receiving member 108 may be a housing of the transmission unit. In various other embodiments, the first component 109 may be a cylinder piston, a throttle valve, or the like.

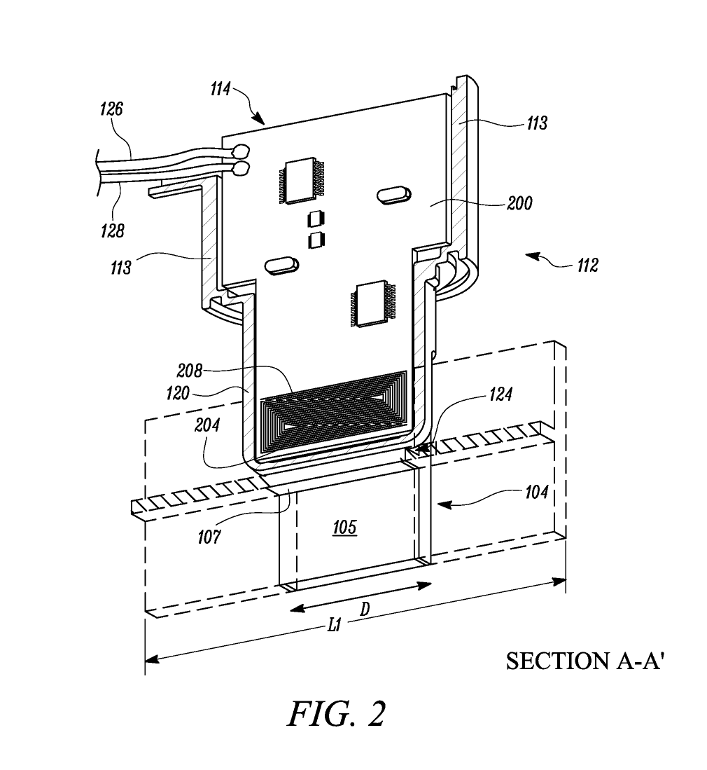

Referring to FIGS. 1 and 2, the first component 109 is movable along a direction “D”. Further, the target member 104 is movable within a first range of movement “L1”. The first range of movement “L1” is defined by the distance the target member 104 travels relative to the receiving member 108. In an alternate embodiment, the target member 104 may be stationary and the receiving member 108 may be movable within a range of movement defined by the distance the receiving member 108 travels relative to the target member 104.

The sensor system 100 includes a housing assembly 112. The housing assembly 112 is structured and arranged to encase a circuit board 200. The housing assembly 112 includes one or more first walls 113 defining a first cavity 114 at one end. The first cavity 114 of the housing assembly 112 may be filled with potting material (not shown) to provide sealing. The housing assembly 112 further includes a projecting portion 120. The projecting portion 120 of the housing assembly 112 is configured to at least partially and movably received within the recessed portion 124 of the target member 104. In the illustrated embodiment, the housing assembly 112 is coupled to the receiving member 108 via fasteners 116. The fasteners 116 may include bolts, screw, rivets, studs or the like. In various embodiments, the housing assembly 112 may be coupled to the receiving member 108 via various other methods for example, welding, adhesives, and the like. The material of the housing assembly 112 may be non-metallic such as ceramic, plastic, or the like.

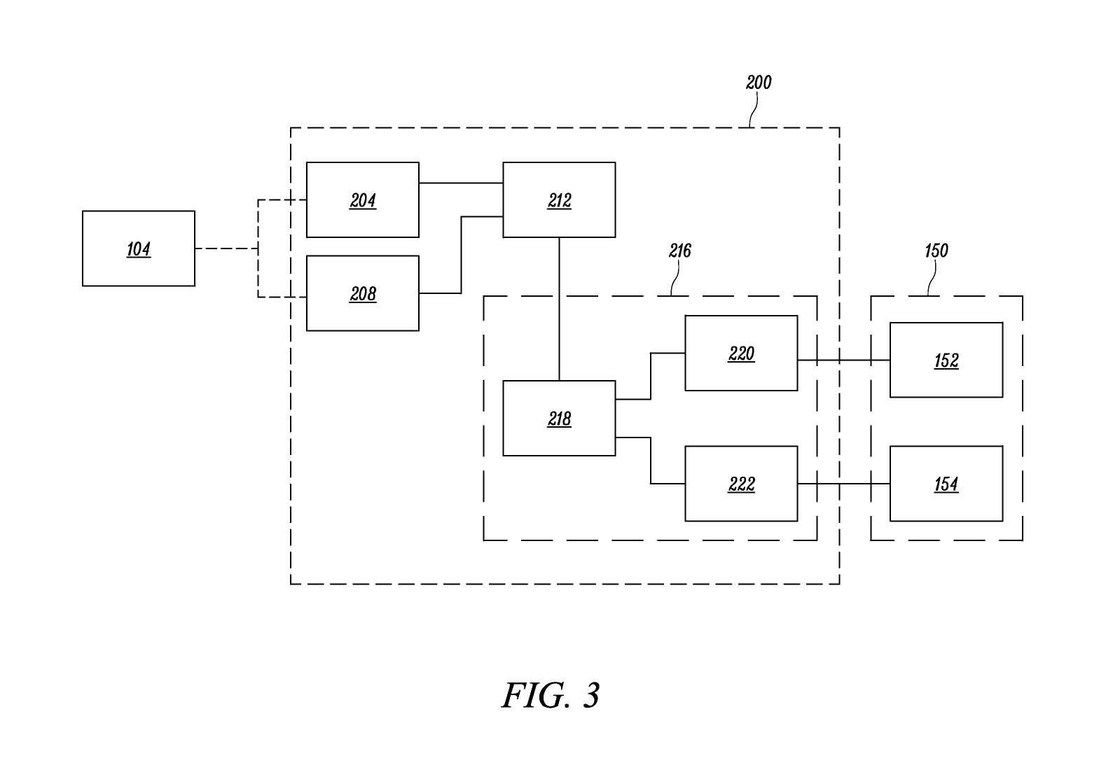

Further, the sensor system 100 is communicably coupled to a first cable 126. The first cable 126 is configured to transmit power from a controller 150 (shown in FIG. 3) to the sensor system 100. Further, the sensor system 100 includes a second cable 128 configured to transmit signals to and from the sensor system 100 to the controller 150. In the illustrated embodiment, the controller 150 is remotely located from the sensor system 100. In an alternative embodiment, the controller 150 may be disposed within the sensor system 100. The controller 150 may embody a single microprocessor or multiple microprocessors configured for receiving signals from the various components of the sensor system 100.

Referring to FIG. 3, the controller 150 includes a power supply module 152. The power supply module 152 may be configured to supply power to the sensor system 100. Further, the controller 150 includes an output module 154. The output module 154 may be configured to process an output of the sensor system 100. Further, the output module 154 may process the output of the sensor system 100 and transfer the output signal to a display unit (not shown). In an embodiment, the output module 154 may be configured to provide a Pulse Width Modulation (PWM) signal to the controller 150. In an alternative embodiment, the output module 154 may be configured to provide an analog signal to the controller 150. In various other embodiment, the output module 154 and the controller 150 may be communicably coupled by a Local Interconnect Network (LIN) or a Controller Area Network (CAN).

Numerous commercially available microprocessors may be configured to perform the functions of the controller 150. It should be appreciated that the controller 150 may embody a machine microprocessor capable of controlling numerous machine functions. A person of ordinary skill in the art will appreciate that the controller 150 may additionally include other components and may also perform other functions not described herein. In an embodiment, the controller 150 may control one or more components of the machine based on the output of the sensor system 100.

The circuit board 200 is configured to sense a position of the target member 104 relative to the receiving member 108 within the first range of movement “L1” between the target member 104 and the receiving member 108. The circuit board 200 includes a first inductive coil 204. The first inductive coil 204 may be printed on the circuit board 200. Moreover, the first inductive coil 204 may have one or more layers. The first inductive coil 204 is configured to generate a first inductive signal in response to a movement between the target member 104 relative to the receiving member 108. In an example, the first inductive signal may indicate a change in parallel resonance impedance of the first inductive coil 204 due to the relative movement between the target member 104 and the receiving member 108. In the illustrated embodiment, the first inductive coil 204 is triangular in shape. However, the first inductive coil 204 may be of alternate shape, for example, circular, rectangular, square or the like.

The circuit board 200 also includes a second inductive coil 208. The second inductive coil 208 is positioned adjacent to the first inductive coil 204. In an example, the second inductive coil 208 may be printed on the circuit board 200 adjacent to the first inductive coil 204. The second inductive coil 208 may also include one or more layers. The second inductive coil 208 is configured to generate a second inductive signal in response to movement between the target member 104 relative to the receiving member 108. In the illustrated embodiment, the second inductive coil 208 is triangular in shape. However, the second inductive coil 208 may be of alternate shape, for example, circular, rectangular, square or the like. In an embodiment, the first and second inductive coils 204, 208 may be substantially identical in design.

It should be noted that the various circuit components, as illustrated in FIG. 2, is exemplary in nature, and the circuit board 200 may include any additional components within the scope of the present disclosure. Various circuit components and their functions are described hereinafter in detail with reference to the FIG. 3.

Referring to FIGS. 2 and 3, the circuit board 200 includes an inductive sensing unit 212 disposed in communication with the first inductive coil 204 and the second inductive coil 208. However, in various alternate embodiments, the circuit board 200 may include separate inductive sensing units 212 for each of the first and second inductive coils 204, 208. The inductive sensing unit 212 is configured to generate a first digital signal and a second digital signal based on the first inductive signal and the second inductive signal, respectively. The inductive sensing unit 212 may include suitable components configured to convert analog signals from the first and second inductive coils 204, 208 to digital signals. In an embodiment, the inductive sensing unit 212 may be configured to detect the first and second inductive signals simultaneously. In various other alternative embodiments, the inductive sensing unit 212 may be configured to detect the first and second inductive signals sequentially.

The circuit board 200 further includes a processing unit 216 disposed in communication with the inductive sensing unit 212. The processing unit 216 is configured to generate an output indicative of the movement between the target member 104 and the receiving member 108 based on at least one of a ratio and a difference between the first digital signal and the second digital signal. The processing unit 216 includes a power conditioning module 220. The power conditioning module 220 is configured to provide regulated power supply received from the controller 150. In an embodiment, the first cable 126 may communicably couple the power conditioning module 220 to the power supply module 152 of the controller 150. The power conditioning module 220 may be configured to regulate voltage of the power supplied from the controller 150. In an example, the power conditioning module 220 may also be configured to change a frequency of electric power received from the power supply module 152 of the controller 150.

The processing unit 216 includes a signal processing module 218. The signal processing module 218 is configured to receive the first digital signal and the second digital signal from the inductive sensing unit 212. The signal processing module 218 may include various signal processing circuits, such as signal filters, amplifiers, and the like, in order to process the first and the second digital signals. Further, the signal processing module 218 is disposed in communication with the power conditioning module 220. In an example, the power conditioning module 220 may provide power to the signal processing module 218. Further, the processing unit 216 includes an output processing module 222. The output processing module 222 may be configured to generate an output indicative of the movement between the target member 104 and the receiving member 108 based on at least one of the ratio and the difference between the first digital signal and the second digital signal. In an embodiment, the output processing module 222 may be calibrated to generate the output based on a distance travelled by the target member 104 relative to the receiving member 108. Further, the output processing module 222 may be configured to transfer the output to the output module 154 of the controller 150. In an embodiment, the second cable 128 may communicably couple the output processing module 222 with the output module 154.

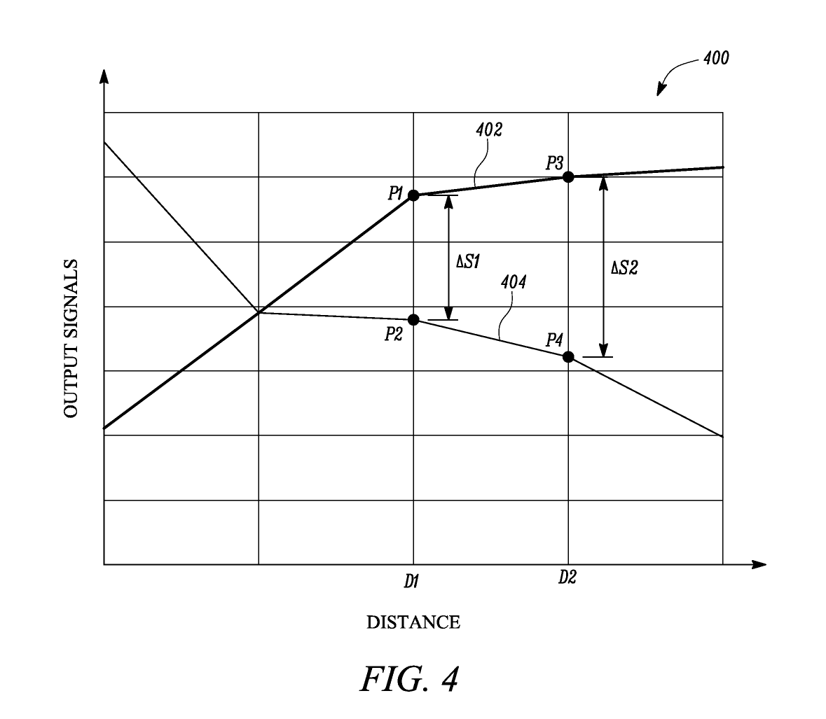

FIG. 4. Illustrates an exemplary output 400 of the processing unit 216 based on the relative movement between the target member 104 and the receiving member 108. In an embodiment, the output 400 is represented as a plot of first and second output signals against a distance of the target member 104 with respect to the receiving member 108 within the first range of movement “L1”. In an embodiment, the first and second output signals may correspond to the first and second digital signals, respectively, from the signal processing module 218. Hence, the first and second output signals may be representative of the first and second inductive signals generated by the first and second inductive coils 204, 208.

The variations of the first and second output signals with position of the target member 104 are illustrated by first and second lines 402, 404, respectively, in FIG. 4. Further, first and second output signals “P1”, “P2” are illustrated on the first and second lines 402, 404, respectively. The first and second output signals “P1”, “P2” correspond to a position “D1” of the target member 104 with respect to the receiving member 108. Similarly, third and fourth output signals “P3” and “P4” are illustrated on the lines 402 and 404, respectively. The third and fourth output signals “P3”, “P4” correspond to a position “D2” travelled by the target member 104 with respect to the receiving member 108.

The processing unit 216 may also be configured to determine the first position “D1” of the target member 104 based on a difference “ΔS1” between the first and second output signals “P1”, “P2”, respectively. Further, the processing unit 216 may also be configured to determine the second position “D2” of the target member 104 based on a difference “ΔS2” of the third and fourth output signals P3, P4, respectively. In an embodiment, a difference between a pair of the output signals (such as “P1”, “P2”) on the first and second lines 402, 404, for a given position of the target member 104 (such as “D1”) may vary substantially linearly with the distance travelled by the target member 104. Hence, using exemplary values “ΔS1” and “ΔS2”, the output processing module 222 may be calibrated with a linear function to provide output a position of the target member 104 relative to the receiving member 108 based on a difference between the first and second output signals. In an alternative embodiment, the processing unit 216 may also be configured to determine the first position “D1” of the target member 104 based on a ratio between the first and second output signals “P1”, “P2”. Further, the processing unit 216 may also be configured to determine the second position “D2” of the target member 104 based on a ratio between the third and fourth output signals P3, P4, respectively.

Though the sensor system 100, as described with reference to FIGS. 1 to 4, is configured to detect the position of the target member 104 along the direction “D”, it may be contemplated that the sensor system 100 may also be configured to detect movements of the target member 104 in three dimensions, for example, along directions perpendicular to the direction “D”. In such a case, the first component 109 along with the target member 104 may also be movable along the directions perpendicular to the direction “D”.

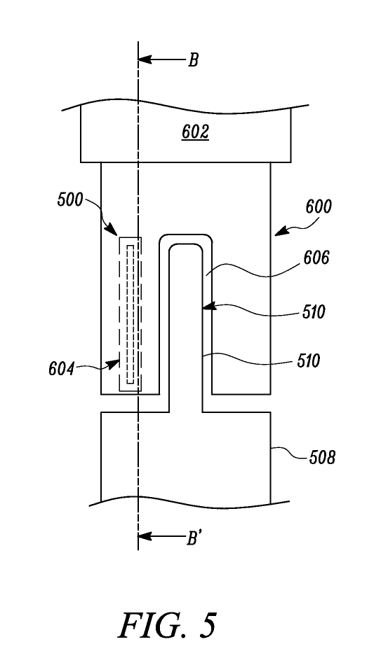

FIG. 5 illustrates a front view of a sensor system 500, according to another embodiment of the present disclosure. The sensor system 500 is used to detect position of a target member 600 relative to a receiving member 508. The target member 600 is placed in proximity to the receiving member 508. In the illustrated embodiment, the target member 600 is coupled to a third component 602, for example, a housing of a transmission unit. In the illustrated embodiment, the third component 602, and hence the target member 600 is stationary and the receiving member 508 is movable. However, in an alternative embodiment, the target member 600 may be movable and the receiving member 508 is stationary.

The target member 600 defines a recessed portion 606. The target member 600 may be configured to encase the sensor system 500. In an example, the target member 600 may include a pocket 604. The pocket 604 may be configured to receive the sensor system 500 therein. In an example, the sensor system 500 may be coupled to the target member 600 via various methods for example, welding, mechanical fasteners, adhesives, and the like.

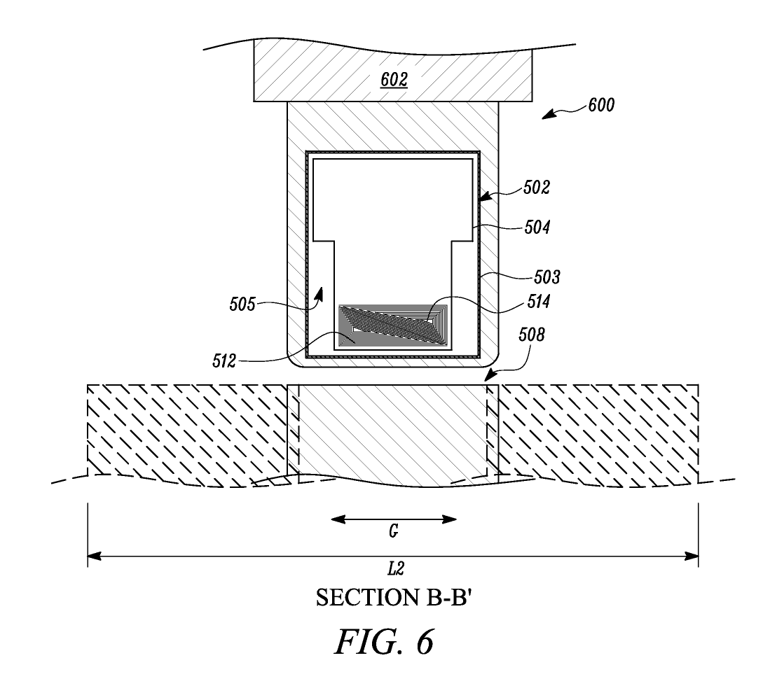

Referring to FIG. 5, the receiving member 508 includes a projecting portion 510. The projecting portion 510 is configured to be at least partially and movably received within the recessed portion 606 of the target member 600. The receiving member 508 may be movable along a second direction “G” (shown in FIG. 6) within a second range of movement “L2”. The range of movement “L2” is defined by the distance the receiving member 508 travels relative to the target member 600.

FIG. 6 illustrates a sectional view of the sensor system 500, according to an embodiment of the present disclosure. The sensor system 500 includes a housing assembly 502. The housing assembly 502 is structured and arranged to encase a circuit board 504. The housing assembly 502 may include one or more second walls 503 structured and arranged to define a second cavity 505. The circuit board 504 may be configured to be received in the second cavity 505. In an example, the second cavity 505 may also be filled with a potting material to provide sealing. The circuit board 504 may be similar in structure, and operation to the circuit board 200 described earlier. As illustrated in FIG. 6, the circuit board 504 includes a first inductive coil 512 and a second inductive coil 514. The circuit board 504 is configured to sense a position of the target member 600 relative to the receiving member 508 within the second range of movement “L2” between the target member 600 and the receiving member 508.

### INDUSTRIAL APPLICABILITY

The present disclosure is related to the sensor systems 100, 500 for detecting positions of the corresponding target members 104, 600 relative to the corresponding receiving members 108, 508. The target members 104, 600 are placed in proximity to the corresponding receiving members 108, 508. As described earlier, the sensor system 100, 500 includes the corresponding housing assemblies 112, 502 structured and arranged to encase the corresponding circuit boards 200, 504. The circuit boards 200, 504 are configured to sense positions of the target members 104, 600 relative to the receiving members 108, 508 within the range of movements “L1”, “L2”, between the target members 104, 600 and the receiving members 108, 508, respectively.

The sensor systems 100, 500 include the corresponding first inductive coils 204, 512 and the corresponding second inductive coil 208, 514 to generate the first and the second inductive signal in response to the movement between the target members 104, 600 relative to the receiving members 108, 508. The sensor systems 100, 500 provide contactless detection of the positions of the target members 104, 600. Hence, any noise and/or vibrations due to sliding contact may be prevented. Further, using a pair of inductive coils and determining at least one of a ratio and a difference between the signals generated by the pair of inductive coils may increase a linearity of the sensor systems 100, 500. The shape of the pair of inductive coils may also be suitably chosen to increase a sensitivity of the sensor system.

Moreover, the circuit boards 204, 512 are encased within the housing assemblies 112, 502 to safeguard the first inductive coils 204, 512, the second inductive coils 208, 514, and various other sensitive circuit components against environmental elements, such as dust, moisture, and the like. The potting material may provide enhanced sealing and allow the cables to be connected to the circuit boards 204, 512 so that an external controller (such as a machine controller) may be communicably coupled to the sensors systems 100, 500. The sensor systems 100, 500 may also provide a compact and cost efficient configuration as all the circuit components are disposed on the circuit boards 204, 512.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A sensor system for detecting a position of a target member relative to a receiving member, the sensor system comprising:
a circuit board comprising:
a first inductive coil configured to generate a first inductive signal in response to a movement between the target member relative to the receiving member;
a second inductive coil being positioned adjacent to the first inductive coil, the second inductive coil configured to generate a second inductive signal in response to movement between the target member relative to the receiving member;
an inductive sensing unit disposed in communication with the first inductive coil and the second inductive coil, the inductive sensing unit configured to generate a first digital signal and a second digital signal based on the first inductive signal and the second inductive signal, respectively; and
a processing unit disposed in communication with the inductive sensing unit, the processing unit configured to generate an output indicative of the movement between the target member and the receiving member based on at least one of a ratio and a difference between the first digital signal and the second digital signal; and
a housing assembly structured and arranged to encase the circuit board;
wherein the circuit board being disposed in the housing assembly and the housing assembly being coupled to one of the target member and the receiving member; and
wherein the target member being placed in proximity to the receiving member and a range of movement being defined by the distance the target member travels relative to the receiving member, the circuit board being configured to sense a position of the target member relative to the receiving member within the range of movement between the target member and the receiving member.

2. The sensor system of claim 1, wherein each of the first inductive coil and the second inductive coil has a triangular shape.
